(19) United States
(12) Patent Application Publication
(10) Pub. No.: US 2001/0052116 A1
(43) Pub. Date: Dec. 13, 2001

(54) Method for the analysis of a test software tool

(76) Inventor: Philippe Lejeune, Sours (FR)

Correspondence Address: James E. Nilles, NILLES & NILLES, S.C., FIRSTAR CENTER, SUITE 2000, 777 EAST WISCONSIN AVENUE, MILWAUKEE, WI, 53202-5345, US

(21) Appl. No.: 09/808,396

(22) Filed: Mar. 14, 2001

(30) Foreign Application Priority Data
Mar. 14, 2000 (FR) 00 03276

(51) Int. Cl. G06F 9/44

(52) U.S. Cl. 717/4

(57) ABSTRACT

Method of analysis of a testing software tool (7) implementing a testing instrument (1) that makes use of the program (8, 13) of the software tool to test test electronic components (2) such that, in the method a recording is made, for each individual operation implemented (14) of the number of times (15) in which this operation is performed by the test instrument and, secondly, a recording is made of the rate of action (17) undergone by the constituent elements of the testing instrument. Thus, a method of this kind leads to preventive maintenance and, as the case may be, to an improvement of the software tool implemented in a testing instrument of this kind.

An object of the present invention is a method for the analysis of a test software tool. It can be used especially in the field of test software implemented by testing instruments to test electronic components, for example to assess the performance characteristics of a software tool used as a manufacturing quality control tool for electronic components since these components are generally manufactured in large batches. In the prior art, there are no known methods for analyzing such test software tools. The value of the invention is that it proposes a method of analysis by which the maintenance of a testing instrument can be organized and the results given by this method of analysis, as well as those given by the test software tool, can be exploited for the purposes of optimizing the software.

In the prior art, there is a known testing instrument that implements a testing programme of the test software in such a way that the test programme comprises a succession of instructions to be performed in order to test the component to be tested. This succession of instructions, as well as criteria of acceptance of the results obtained following the performance of these instructions, are stored in a data memory of the testing instrument. A testing instrument generally comprises a microprocessor to exchange information with the data memory. Furthermore, the microprocessor controls a multiplexer of the testing instrument. By means of the multiplexer, potentials that have to be applied to particular points of the electronic component to be tested are associated with pins of the testing instrument. Furthermore, the multiplexer is also used to identify potentials sent out by the component in the pins. The microprocessor records the potentials sent by each of the pins, and this constitutes results of the test programme. The results are then recorded in a measurement memory of the testing instrument.

To ensure the quality of the results given by a testing instrument of this kind, it must be seen to it that each of the electronic components constituting the testing instrument itself work properly. Thus, in the prior art, frequent repairs have to be made to the testing instrument. For example, if a large number of components to be tested are rejected consecutively, and this happens for the same reason, then the testing instrument must be stopped and a search must be made for a malfunction in its constituent electronic components. Similarly, in another example, if the testing instrument can no longer carry out the test programme entirely, then testing with this instrument has to be stopped, and a search must be made for malfunctions in the instrument. Now searching for malfunctions (or troubleshooting) is a painstaking operation in the prior art. Indeed, searching for malfunctions in a testing instrument has to be done a logical order that depends on a frequency of appearance of malfunctions for each of the components forming the testing instrument. This order of searching for malfunctions is done empirically as a function of observations made by users of the testing instrument. This search for malfunctions is done independently of the knowledge of the instructions that are contained in the test programme, and that put the different components of the instrument into operation.

In the prior art, the use of a testing instrument of this kind implementing a test programme raises problems. Indeed, a testing instrument of this kind frequently goes out of order and does so unexpectedly. This may be troublesome when a malfunction takes place during a campaign of tests on batches of components to be tested. Furthermore, when the testing instrument is stopped because of a malfunction, the repairing of this malfunction may sometimes take a long time inasmuch as there is no method that can be used to rapidly find the cause of the malfunction and ways of resolving it. Indeed, the empirical approach used does not optimize the resolution of this type of problem. Furthermore, in the prior art, there are no means of preventive maintenance for minimizing the occurrence of malfunctions. Indeed, the problem has to be confronted only when the time comes. There are no ways to prevent it.

It is an object of the invention is to overcome the problems referred to by proposing a method for the analysis of a test software tool such that the programme of analysis records a number of performances of a given operation of a programme of tests of the software. A test software may comprise programmes such that each programme is specific to a given type of electronic component. A test programme comprises operations or instructions to be performed by means of the testing instrument. Then, for each test programme, the number of performances of each of the operations is recorded. Furthermore, the method of analysis also assesses the number of times in which an electronic component of the test instrument is acted upon by any of the test programmes of the test software. Thus, it is possible to deduce a classification of the electronic components of the testing instrument as a function of the number of times that it is acted upon by the software. Furthermore, it is also possible to know the operations most frequently performed by each of the test programmes. Depending on the method of the invention, it is possible to assess the rate of wear and tear suffered by each of the components of the testing instrument and also foresee the progress of this rate of wear and tear for each of the components when a series of tests is launched on a series of components to be tested. It is thus possible to plan for premature replacement or even a frequency of replacement of each of these components so as to prevent the appearance of malfunctions.

Furthermore, this information given by the method of analysis can also be used to optimize the ordering of the operations contained in each of the test programmes. This optimization seeks to reduce the number of instances of performance of the most frequent operations. Furthermore, inasmuch as it is possible to use a method of analysis to find out a duration of the performance of each operation, it will preferably be sought to reduce the number of performances of the lengthiest operations. The approach made by the invention provides for preventive maintenance on the testing instrument and also helps optimize the software or even the test programmes implemented by this software.

The invention therefore relates to a method of analysis of a testing software tool characterized in that it comprises the following steps:

the use, in a testing instrument, of a programme of this software to test electronic components;

the recording of the numbers of occurrences of the performance of identical test operations of the programme.

The invention will be understood more clearly from the following description and the appended figures. These figures are given purely by way of an indication and in no way restrict the scope of the invention. Of these figures:

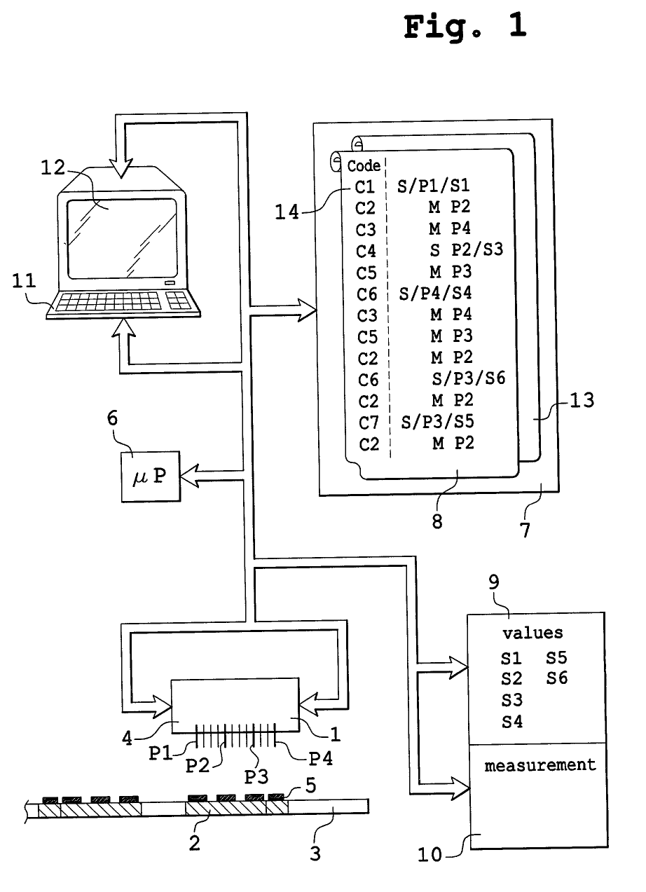

FIG. 1 is a drawing of a method of analysis of a software tool according to the invention;

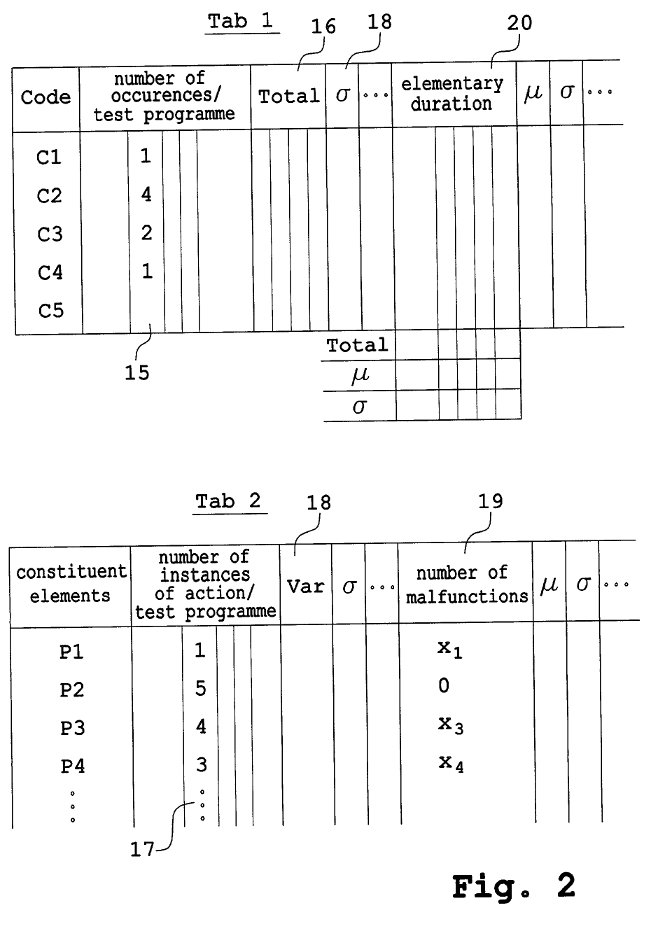

FIG. 2 is a drawing of analysis of data according to the method of analysis of the invention.

FIG. 1 shows a testing instrument 1 to test an electronic component 2. The electronic component 2 is for example a card provided with an electronic microcircuit such as a smart cart or a memory component. In general, this electronic component 2 is presented on a wafer 3 such as a wafer 3, generally comprising several electronic components such as 2 to be tested. The components of a wafer 3 of this kind may all be identical to one another or possibly different. In a preferred example, a wafer 3 has integrated circuits that are all identical to one another.

The testing instrument 1 has a module 4 comprising pins, for example P1, P2, P3 and P4, to come into contact with particular points 5 of the electronic component 2 to be tested. The module 4 may comprise a multitude of pins to come into contact with a multitude of particular points of the electronic component 2. The pins are distributed according to a particular geometry which can be used, in a known way, to place each of the pins respectively before a particular point of the electronic component 2 to be tested.

The testing instrument 1 also comprises a microprocessor 6 to manage information flows, such as data, control and address buses sent from the module 4 and received by this module 4. The microprocessor 6 calls up a test programme 8 in a software tool 7. The test programme 8 that is called up depends on the nature of the component to be tested. The software tool 7 has several test programmes such as 8.

In a preferred example, an operator may drive the microprocessor 6 by means of a keyboard 11 and may receive information sent by the microprocessor 6 through a screen 12. For example, a user may use the keyboard 11 to impose the use of the programme 8, or another programme 13 stored in the software tool 7, on the microprocessor 6. Furthermore, this user may, if necessary, see a display on the screen 12 of the results of measurements requested in the programme 8 or the results of the analysis procedure of the programme 8 or even, if necessary, results of the method of analysis of the software tool 7.

The programme 8 comprises several operations or lines of instructions 14. These operations 14 are executed by means of the module 4. The lines of instructions 14 are identified by codes, for example C1, C2, C3, C4, C5, C6, C7. One and the same instruction line or operation 14 may be repeated several times within one and the same programme. For example, as shown in FIG. 1, the instruction line whose code is C1 is repeated once in the programme 8 while the instruction line C2 is repeated four times in this same programme 8.

In one example, the programme 8 essentially comprises two types of instruction. Firstly “send a potential” type instructions, for example S/P1/S1 with the code C1 aimed at supplying power to the pin P1 with a value S1. Furthermore, the programme 8 comprises “measurement” type instructions, for example MP2, coded C2, designed to request a measurement of a potential of the pin P2. The programme 8 is executed line after line by the microprocessor 6. In the case of an S/P1/S1 type instruction line, the microprocessor 6 calls up the value S1 in the data memory 9. In the case of the instruction line MP2, the measurement of the potential of the pin P2 is stored by the microprocessor 6 in the measurement memory 10.

In FIG. 2, in a table Tab1, for each distinct instruction line 14 identified by its code, a number of occurrences of this instruction 14 during the performance of a test programme on an electronic component 2 is recorded in a column 15 of this table. Since the software tool 7 is used to test several electronic components such as 2, the table Tab1 comprises several columns such as 15. Each column such as 15 comprises the number of occurrences of each instruction for all the instructions proposed by the software tool 7, at each new performance of a programme such as 8 or 13 of the software tool 7.

In a table of this kind, it is also possible to make a recording, in a column 16, of a total number of occurrences for each of the instructions 14. A column 16 may correspond to the sum of the occurrence numbers, during the performance of one and the same program such as 8. There are thus several columns such as 16 in the table Tab1, one per programme such as 8 or 13 proposed by the software 7. It is also possible to obtain a total, in an other column such as 16, corresponding to a total of the number of occurrences of an instruction due to the set of programmes of the software tool 7, namely a total of the number of occurrences due to each programme of the software tool 7 implementing this instruction. Furthermore, it is possible, in a column 18, to record statistical values computed from these measured data. For example, it is possible to compute a mean standard deviation and/or a variance of this data.

In the same way as for each instruction 14 in the table Tab1, it is possible to prepare a second table Tab2 for each of the constituent elements of the module 4, especially for those implemented by programmes such as 8 of the software tool 7. The module 4 can be subdivided into elements such as the pins P1, P2, P3 and P4 and electronic microcircuits to drive each of these pins. The table Tab2 therefore comprises a line for each of these elements. In the table Tab2, an assessment is made of a rate of action undergone by each of the constituent elements of the module 4. Thus, depending on the example of FIG. 1, a situation is obtained where the pin P1 has been acted upon once while the pin P2 has been acted upon five times during the performance of the programme 8 to test the component.

The rates of action undergone by the constituent elements are then stored in a column 17. For each performance of a programme such as 8, a recording is made, in a column such as 17, of the rates of action on components implemented. A table Tab2 of this kind may comprise several columns such as 17. It may have as many columns as there are performances of programmes of the software tool 7. It is possible, in a column 8, to record the total rates of action on each constituent element, this total being the sum of the instances of action on components due to all the programmes implemented to test the components or implemented during a given period. Thus, it is also possible to estimate a total of the rate of action, due to the software tool 7, on each of the constituent elements. Statistical analyses can be made on the values. For example it is possible, for each constituent element, to assess a mean standard deviation and/or a variance and/or a mean in a column such as 18.

It is also possible, in the table Tab2, to make an assessment, for each component, of a rate of instances of action undergone by a component since it was installed in the testing instrument. Since all the constituent programmes of a testing instrument are not renewed simultaneously, it is planned to reset the counters individually for each of the components.

In each of the two tables described here above, it is possible, from this information, to deduce the means of classifying the operations of a programme, or of a software tool, according to an number of occurrences of performance. It is possible for example to classify these instructions or operations with respect to one another. In particular this classification can be done in descending order as a function of their total number of occurrences of performance. Thus, with a classification of this kind it is possible to highlight the instructions most frequently implemented by a test programme or, more generally, most frequently implemented by the test software tool.

Similarly, from the rate of action on each of the constituent elements of the testing instrument, it is possible to determine a total of the number of instances of action on each of these elements. The total can be obtained either for a programme in particular or for all the programmes implemented by the test software tool 7. Thus, it is possible to know which are the elements of the testing instrument that are most acted upon by the test programme. It is therefore possible to carry out a classification among these constituent elements in descending order with respect to the total number of instances of action on components. Thus, this classification, especially the one done in descending order according to the total number of instances of action on a component since it was installed, is used to determine a preferred order of searching for malfunctions. Indeed, the elements of a testing instrument that are most acted upon are those most at risk in the event of malfunction. These are the elements that are most weakened by all the tests performed and they are therefore generally the first to suffer malfunctions. The knowledge of this order will therefore make it possible to carry out a simplified and faster search for malfunctions.

Furthermore, it is possible, in this same table, to record a number of malfunctions observed and identified for each of the constituent elements. For example, in a column 19 of the table Tab2, numbers x1, x3 and x4 are noted down for the constituent elements P1, P3 and P4 respectively. This knowledge is empirical and is entered by a user of the testing instrument. The statistical lifetime of the components is known.

Thus, it is possible, for an element of the testing instrument, to correlate the number of empirically observed malfunctions with its rate of being acted upon since it was installed. In compiling data obtained on several consecutive components set up at one and the same place in the testing instrument, a correlation observed between the rate of action on this element and the number of malfunctions is used to determine a theoretical lifetime of this element in the testing instrument. Furthermore, since the number of instances of action on this component per programme and per software tool is known, it is possible to forecast the amount of time (i.e. the theoretical lifetime) at the end of which this constituent element has to be changed. To improve the maintenance of a testing instrument, preferably, this theoretical lifetime is determined as being smaller than the statistical lifetime so that there are no longer any malfunctions. Thus, preventive maintenance is done. It is possible in one example to redetermine the theoretical lifetime of a component whenever the number of malfunctions observed for this component becomes too great.

Similarly, since the type of test campaigns that will be implemented on the testing instrument is known in advance, it is possible to compute an expected number of times in which each component will be acted upon, namely it is possible to compute the incrementation of the rate of action on each component. It is then possible, as the case may be, to plan for a possible change in a component before launching a campaign of tests on a set of components to be tested, so as to avoid having to stop the tests in the middle of this set of components.

Furthermore, for each operation of a test programme, it is also possible to make a recording, in a column 20 of the table Tab1, of the elementary duration observed whenever the operation is implemented. There is thus a column such as 20 for each performance of the operation considered. It is then possible to make statistical computations such as computations of means or mean standard deviations on the basis of these values. The periods of time are specific to each of the test operations.

It is furthermore possible to assess a total duration of performance of a test programme. The computation can be made for each performance of a test programme on a component to be tested. Thus, as many values are obtained as there are components tested. It is possible to compute a total, a mean, a mean standard deviation or other statistical values from these total durations of performance of a test on a component to be tested.

Less formally, it is possible quite simply to record durations of test sequences. A sequence then comprises several successive test operations. To improve the software tool, it is possible to optimize each program by reducing its period of performance of a test on a component. For this purpose, it is possible to establish two main directions of searching for a reduction in the elementary duration of a program. The first direction seeks to reduce the number of operations identified as the lengthiest operations according to the table Tab1. A second direction of searching for reduction may be that of seeking to reduce the most frequently implemented operations, also according to the data of Tab1. Indeed, it may be thought that a frequently implemented operation can be used for different test functions and then may be performed only once. It should then be possible to use results obtained by this operation for several distinct tests.

1. Method of analysis of a testing software tool (7) characterized in that it comprises the following steps:
the use, in a testing instrument (1), of a programme (8) of this software to test electronic components (2);
the recording of the numbers (15, 16) of occurrences of the performance of identical test operations (14) of the programme.

2. Method according to claim 1, characterized in that
the test operations are classified as a function of a number of statistical occurrences of execution.

3. Method according to one of the claims 1 to characterized in that
a rate of instances of action (17) undergone by the constituent elements of the testing instrument is deduced or recorded.

4. Method according to claim 3 characterized in that
the constituent elements are classified as a function of a statistical rate of instances of being subjected to action.

5. Method according to one of the claims 3 to 4 characterized in that
a classification of the constituent elements of the testing instrument is determined as a function of their rates of being acted upon, to determine an optimized searching order to be implemented in the event of a malfunction in this instrument.

6. Method according to one of the claims 3 to 5 characterized in that
a number (19) of occurrences of malfunctions is recorded for each of the constituent elements of the testing instrument,
a statistical lifetime of these constituent elements is determined by correlating the rate of instances of being acted upon and the number of occurrences of malfunctions for each of the elements.

7. Method according to claim 6 characterized in that
the constituent elements of the testing instrument are changed preventively at a frequency smaller than their statistical lifetime.

8. Method according to one of the claims 1 to 7 characterized in that
durations of execution of sequences of the test programme are recorded,
the software tool is optimized by reducing a duration of execution of a test programme on an electronic component, a reduction of this duration being obtained by reducing the number of executions of the longest sequences, and by reducing the number of occurrences of executions of the most frequent operations.
